(19) United States
(12) Patent Application Publication
(10) Pub. No.: US 2007/0033233 A1
(43) Pub. Date: Feb. 8, 2007

(54) Log management system and method of using the same

(76) Inventors: Min Jae Hwang, Seoul (KR); Hyun-Woo Park, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/498,411

(22) Filed: Aug. 2, 2006

(30) Foreign Application Priority Data
Aug. 5, 2005 (KR) 10-2005-0071921
Aug. 11, 2005 (KR) 10-2005-0073871

(51) Int. Cl. G06F 17/30

(52) U.S. Cl. 707/200

(57) ABSTRACT

A log management system and method which can collect and manage a log in an online service system including a server application and a client application is provided. The log management system includes: a client terminal which executes a client application for collecting the log of the online service, and transmits the collected log in a predetermined format at a predetermined point in time via a network; and a log management server which is independent from an online service server executing a server application providing a service that is corresponding to the client application, and which receives the log from the client terminal and stores the received log for each online service. Accordingly, a log of an online service may be more effectively managed.

### CROSS-REFERENCE TO RELATED APPLICATIONS

This application claims the benefit of Korean Patent Application No. 10-2005-0071921, filed on Aug. 5, 2005, and Korean Patent Application No. 10-2005-0073871, filed on Aug. 11, 2005, in the Korean Intellectual Property Office, the disclosure of which are incorporated herein by reference.

### BACKGROUND

1. Field of the Invention

The present disclosure relates to a log management system and method, and more particularly, to a log management system and method which can collect and manage a log in an online service system including a server application and a client application.

2. Description of the Related Art

As Internet use has become widespread, an online service system, which provides an online service by a client application interoperating with a server via a network, becomes popular. In this case, the client application is installed in each user terminal and the server application is installed in a service server. Examples of the online service may include online games, such as ‘Lineage’, ‘Kartrider’, and ‘You're the king of golf’.

A term ‘log’ designates a kind of diary which records a flight log of an aircraft or a voyage log of a vessel. In a computer terminology, the term ‘log’ designates data which is a recording of input/output information of a computational device. A log may also include recorded event information, such as transactions that occur on a computer. Accordingly, a web log is a diary with respect to a voyage in the Internet and also designates “records with respect to operations via a web server”. The web log records what kind of content a customer visited and requested, and also whether the requested content has been well-serviced.

The log is utilized for analyzing use patterns of users with respect to the online service. As an example, log data may be utilized for recording a number of simultaneous connectors of the ‘You're the king of golf’ game, an average utilization time of users, a most favored character, or the like.

### SUMMARY

FIG. 1 is a block diagram illustrating an online service system according to a conventional art.

Referring to FIG. 1, the online service system according to the conventional art includes client terminals 110-1, 110-2, . . . , 110-N, and online service servers 120-1, 120-2, . . . , 120-N.

Each of the client terminals 110-1, 110-2, . . . , 110-N is connected to each of the online service servers 120-1, 120-2, . . . , 120-N, via a network, such as the Internet and the like. In this case, a client application is installed in each of the client terminals 110-1, 110-2, . . . , 110-N, to perform an online service that is provided by a portion or all of the online service servers 120-1, 120-2, . . . , 120-N.

As an example, the online service server 120-1 may be a ‘Lineage’ game server and the online service server 120-2 may be a ‘You're the king of golf’ game server. In this case, a ‘You're the king of golf’ game client application for performing a ‘You're the king of golf’ game service may be installed in each of the client terminals 110-1, 110-2, . . . , 110-N.

Also, at least two online service servers may provide a single online service. As an example, the online service servers 120-1 and 120-2 may provide the ‘You're the king of golf’ game service.

In a conventional online service system, the online service servers 120-1, 120-2, . . . , 120-N collect logs containing recorded event information. As an example, when the client terminal 110-1 accesses the online service server 120-1 to play the ‘Lineage’ game, the online service server 120-1 providing the ‘Lineage’ game service collects logs including a time, a content type, a user identifier, a user name, a user's Internet Protocol (IP) address, and a game identifier.

As described above, when logs are collected for a predetermined time in the online service servers 120-1, 120-2, . . . , 120-N, the collected logs are dumped and analyzed in a separate server from the online service servers 120-1, 120-2, . . . , 120-N. Generally, since a significant amount of data is required to be dumped, dumping of the collected logs was performed in the middle of night to prevent system overload.

Also, to collect additional log data, a server program was required to be updated by correcting and compiling a server application of an online service server, and uploading the compiled server application. Accordingly, the online service had to be blocked.

Also, when log for analysis were collected in the online service servers 120-1, 120-2, . . . , 120-N, another server had to dump the collected logs to analyze the logs. Accordingly, it took a predetermined time to dump log data and finally analyze the log data. As an example, when analyzing a one day log with respect to the ‘You're the king of golf’ game service for December 25, the log was not able to be analyzed immediately after midnight on December 26, and had to wait until the online server completed dumping the log.

Accordingly, a log management system and method which can easily manage a log of an online service at any desired time, without blocking an online service, is required.

The present disclosure provides a log management system and method which can easily manage a log of an online service at any desired time without blocking an online service.

The present disclosure also provides a log management system and method which enables a distributed client side, not a server side, to collect log data and transmit the collected log data every time the log data is collected, and thereby can quickly analyze the collected log data without a need to dump a huge amount of data at once.

The present disclosure also provides a log management system and method which can quickly collect an additional log while not blocking online service, even when a client side collects log data and also is required to collect an additional log.

The present disclosure also provides a log management system and method which can automatically collect and manage logs corresponding to online service servers that provide different online services.

The present disclosure also provides a log management system and method which enables any user to easily apply a log in various types of environments by transmitting the log using a HyperText Transfer Protocol (HTTP), and also can prevent blocking of a transmission which is caused by a router or a firewall.

The present disclosure also provides a log management system and method which can immediately analyze a collected log and instantaneously handle a hacking attempt.

The present disclosure also provides a log management system and method which can pre-process and store a portion of collected logs immediately when the portion of logs is collected, and post-process remaining logs while storing the remaining logs, and thereby can effectively manage a huge amount of log data.

The present disclosure also provides a log management system and method which can effectively collect and manage log data with respect to various types of applications by providing a template where an item of a collected log is set.

The present disclosure also provides a log management system and method which can change a selection, grouping, and an arrangement method with respect to collected logs by simply manipulating a pointing device such as a mouse.

The present disclosure also provides a log management system and method which enables various types of online service operators to share a frequently utilized template, a structured query language (SQL) query, and the like, and thereby can effectively manage a log.

According to an aspect of the present disclosure, there is provided a log management system for managing a log of an online service, the log management system including: a client terminal which executes a client application for collecting the log of the online service, and transmits the collected log in a predetermined format at a predetermined point in time via a network; and a log management server which is independent from an online service server executing a server application providing a service that is corresponding to the client application, and which receives the log from the client terminal and stores the received log for each online service.

According to another aspect of the present disclosure, there is provided a method of managing a log of an online service, the method including: a client application, which is executed in the client terminal and collects the log of the online service, interoperating via a network with a server application which is executed in an online service server; and a log transmission module which is installed in the client terminal, transmitting the collected log in a predetermined format at a predetermined point in time via the network.

In this case, the log management method may further include a log management server receiving and storing the log which is transmitted via the network.

Also, the online service is provided by the client application and the server application interoperating with each other via the network, such as the Internet. Examples of the online service may include an online game service, such as ‘Lineage’, and ‘You're the king of golf’.

Also, ‘the client application collecting a log’ designates that the client application installed in the client terminal performs creating a log file, and storing and updating log data in the log file, during a process of providing an online service in interoperation with the server application.

Also, ‘transmitting the collected log at a predetermined point in time’ may designate ‘transmitting the collected log periodically at certain time intervals’. As an example, the collected log may be transmitted every one minute. Also, transmitting the collected log at a predetermined point in time may designate ‘transmitting the collected log when the client application is terminated’.

According to still another aspect of the present disclosure, there is provided a method of managing a log of an online service, the method including: a server application which is executed in an online service server, interoperating with a client application which is executed in a client terminal via a network; a log management server receiving a log from the client terminal and determining whether a pre-processing is required for the received log; and pre-processing the received log and storing the pre-processed log when the pre-processing is required, and storing the received log as it is when the pre-processing is not required.

In this case, the log includes a generally utilized web log. Also, the log may include log information which has occurred in the client application. Also, the log may include information about an inappropriate act, such as a hacking attempt of an online service user.

Also, ‘processing the log’ includes a simple calculation, such as a counting using the collected log, arranging, grouping, and the like. Specifically, ‘processing the log includes all the functions that may be performed by a structured query language (SQL) query.

### BRIEF DESCRIPTION OF THE DRAWINGS

The above and/or other aspects and advantages of the present disclosure will become apparent and more readily appreciated from the following detailed description, taken in conjunction with the accompanying drawings of which:

FIG. 1 is a block diagram illustrating an online service system according to a conventional art;

FIG. 2 is a block diagram illustrating a log management system according to an exemplary embodiment of the present disclosure;

FIG. 3 is a block diagram illustrating an example of a client terminal shown in FIG. 2 according to an exemplary embodiment of the present disclosure;

FIG. 4 is a block diagram illustrating another example of a client terminal shown in FIG. 2 according to an exemplary embodiment of the present disclosure;

FIG. 5 is a diagram illustrating an example of a log stored in a log management server according to an exemplary embodiment of the present disclosure;

FIG. 6 is a flowchart illustrating a log management method according to an exemplary embodiment of the present disclosure;

FIG. 7 is a flowchart illustrating a log transmission method according to an exemplary embodiment of the present disclosure;

FIG. 8 is a diagram illustrating an example of a template which is provided in a log management server shown in FIG. 2, according to an exemplary embodiment of the present disclosure;

FIG. 9 is a diagram illustrating an example of a log providing screen of a subject which is created using a pre-processing template, according to an exemplary embodiment of the present disclosure;

FIG. 10 is a diagram illustrating an example of a log providing screen of a subject which is created using a post-processing template, according to an exemplary embodiment of the present disclosure;

FIG. 11 is a diagram illustrating an example of a screen for setting a subject shown in FIG. 10, according to an exemplary embodiment of the present disclosure;

FIG. 12 is a diagram illustrating an example of a screen which is provided via a log management server according to an exemplary embodiment of the present disclosure;

FIG. 13 is a diagram illustrating another example of a screen which is provided via a log management server according to an exemplary embodiment of the present disclosure;

FIG. 14 is a diagram illustrating still another example of a screen which is provided via a log management server according to an exemplary embodiment of the present disclosure;

FIG. 15 is a flowchart illustrating a log management method according to another exemplary embodiment of the present disclosure; and

FIG. 16 is a flowchart illustrating a log management method according to still another exemplary embodiment of the present disclosure.

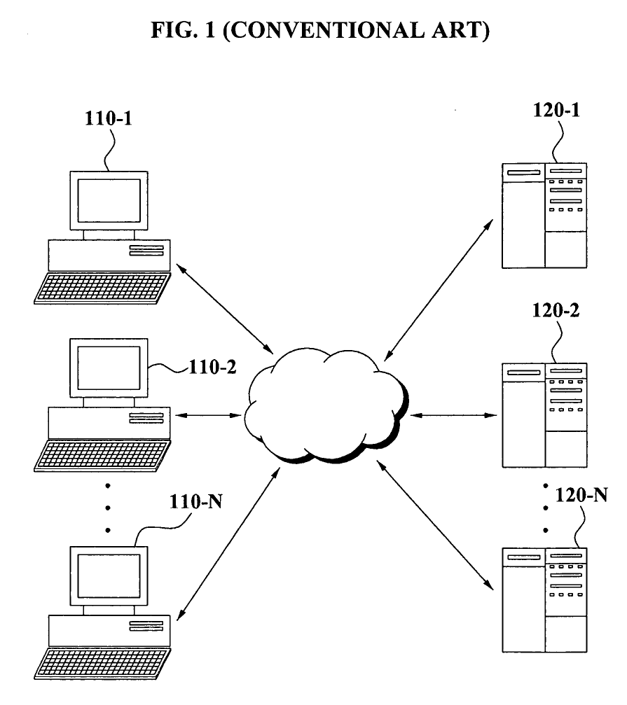

### DETAILED DESCRIPTION

Reference will now be made in detail to exemplary embodiments of the present disclosure, examples of which are illustrated in the accompanying drawings, wherein like reference numerals refer to the like elements throughout. The exemplary embodiments are described below in order to explain the present disclosure by referring to the figures.

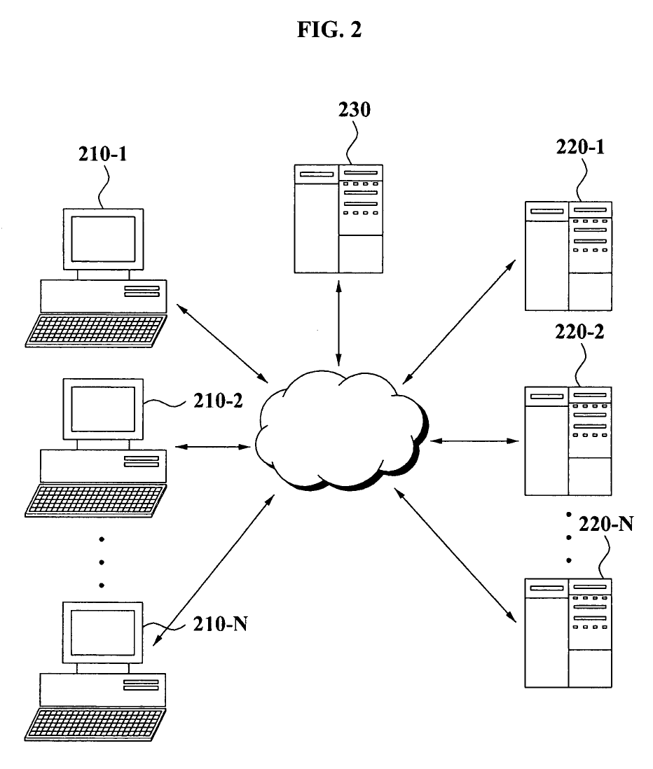

FIG. 2 is a block diagram illustrating a log management system according to an exemplary embodiment of the present disclosure.

Referring to FIG. 2, the log management system according to the present embodiment includes client terminals 210-1, 210-2, . . . , 210-N, and online service servers 220-1, 220-2, . . . , 220-N.

Each of the client terminals 210-1, 210-2, . . . , 210-N may be a computer, a pocket personal computer (PC), a notebook computer, a personal digital assistant (PDA), a mobile phone, a game device, and the like.

A client application is installed in each of the client terminals 210-1, 210-2, . . . , 210-N. Also, at least two client applications may be installed in each of the client terminals 220-1, 220-2, . . . , 220-N.

Each client application interoperates with a server application that is installed in each of the online service servers 220-1, 220-2, . . . , 220-N. As an example, a game client for a ‘You're the king of golf’ game service and another game client for a ‘Lineage’ game service may be installed in the client terminal 210-1. In this case, the ‘You're the king of golf’ game service may interoperate with the server application that is installed in the online service server 220-1. Also, the ‘Lineage’ game service may interoperate with the server application that is installed in the online service server 220-2.

Each of the online service servers 220-1, 220-2, . . . , 220-N may execute a server application for a single online service. Also, at least two of the online service servers 220-1, 220-2, . . . , 220-N may execute the server application for the single online service. As an example, the online service servers 220-1 and 220-2 may be servers for the ‘You're the king of golf’ game service.

Each of the client applications collects a log during a process of providing an online service, in interoperation with the server application that is installed in each of the online service servers 220-1, 220-2, . . . , 220-N. In this case, the log may include a time, a content type, a user identifier, a user name, a user's Internet Protocol (IP) address, and a game identifier.

Also, the client application may include a log collecting module which collects the log during the process of performing the online service in interoperation with the server application. In this case, the log collecting module may be a software module which is installed in client application software.

Also, a log transmission module may be installed in each of the client terminals 210-1, 210-2, . . . , 210-N. The log transmission module transmits the collected log in a predetermined format at a predetermined point in time via a network, during the process of providing the online service in interoperation with the server application of the online service server. In this case, the network includes wired/wireless Internet.

According to embodiments, the log transmission module may transmit the collected log at certain time intervals while the client application is being executed. As an example, the log transmission module may transmit the collected log every one minute.

Also, according to embodiments, the log transmission module may transmit the collected log, when the client application is terminated.

A different log transmission module may be installed for each corresponding client application. Also, at least two client applications may share a single log transmission module. As an example, each of a ‘You're the king of golf’ application and a ‘Lineage’ application may include a corresponding log transmission module. Also, the ‘You're the king of golf’ application and the ‘Lineage’ application may share the single log transmission module.

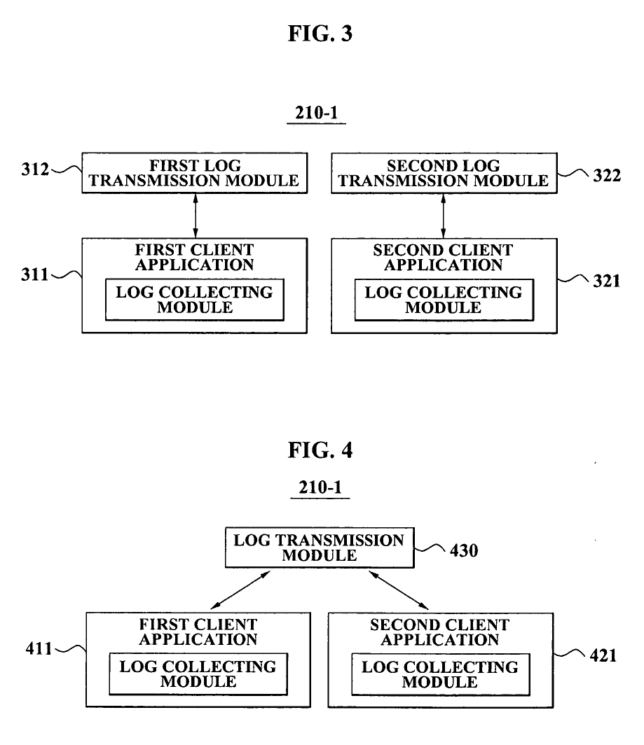

FIG. 3 is a block diagram illustrating an example of the client terminal 210-1 shown in FIG. 2 according to an exemplary embodiment of the present disclosure.

Referring to FIG. 3, the client terminal 210-1 shown in FIG. 2 includes a first client application 311 and a second client application 321, and a first log transmission module 312 and a second log transmission module 322.

Each of the first client application 311 and the second client application 321 includes a log collecting module which collects the log of the online service while providing the online service in interoperation with the server application.

The first log transmission module 312 transmits the log which is collected in the first client application 311, in correspondence to the first client application 311. Also, the second log transmission module 322 transmits the log which is collected in the second client application 322, in correspondence to the second client application 322.

As an example, the first client application 311 may be a ‘Lineage’ game client application, and the second client application 321 may be a ‘You're the king of golf’ game client application. In this case, the first log transmission module 312 may transmit a ‘Lineage’ game log, and the second log transmission module 322 may transmit a ‘You're the king of golf’ game log.

FIG. 3 illustrates an example of installing two, the first client application 311 and the second client application 321, but the present disclosure is not limited thereto. The client terminal 210-1 may include at least three client applications and also may include only a single client application. In FIG. 3, each log transmission module is provided for each client application. Accordingly, a number of log transmission modules is equal to the number of client applications.

FIG. 4 is a block diagram illustrating another example of the client terminal 210-1 shown in FIG. 2 according to an exemplary embodiment of the present disclosure.

Referring to FIG. 4, the client terminal 210-1 includes a first client application 411 and a second client application 421, and a log transmission module 430.

The log transmission module 430 transmits a log which is collected in each of the first client application 411 and the second client application 421, via a network. Namely, the first client application 411 and the second client application 421 share the log transmission module 430.

As an example, the first client application 411 may be a ‘Lineage’ game client application, and the second client application 421 may be a ‘You're the king of golf’ game client application. In this case, the log transmission module 430 may transmit both a ‘Lineage’ game log and a ‘You're the king of golf’ game log.

FIG. 4 illustrates an example of installing two, the first client application 411 and the second client application 421, but the present disclosure is not limited thereto. The client terminal 210-1 may include at least three client applications and also may include only a single client application. Also, the at least three client applications may share the single log processing module.

Although the client terminal 210-1 shown in FIG. 2 has been described above, description related to the client terminal 210 may be applied to other client terminals 210-2, . . . , 210-N shown in FIG. 2.

The log transmission module 430 may transmit the collected log using an HTTP. In this case, 80 ports may be utilized. As described above, the collected log may be easily transmitted in any type of client model using an HTTP and 80 ports. Also, it is possible to prevent blocking of a transmission which is caused by a router or a firewall.

In this case, the log transmission module 430 may transmit the collected log in a form of a Uniform Resource Locator (URL) by using an HTTP.

Also, the log transmission module 430 may enable the collected log to be transmitted in an existing Internet infrastructure using a Simple Object Access Protocol (SOAP), without any unexpected blocking due to a firewall.

Referring again to FIG. 2, the log management server 30 receives and stores the log which is transmitted from the client terminal via the network, such as wired/wireless Internet.

In this case, the log management server 230 may store the log, which is transmitted from the client terminal, in a separate database, such as an oracle database.

Also, the log management server 230 may store the received log for each online service.

Also, the log management server 230 determines whether a pre-processing is required when storing the log that is received from the client terminal. As a result of the determination, when the pre-processing is required, the log management server 230 pre-processes the received log, and when the pre-processing is not required, stores the received log as it is.

In this case, the pre-processing includes all the processes, such as arranging, grouping, and counting with respect to the log that is received from the client terminal, and creating an additional item using the received log. As an example, the pre-processing may designate counting a number of users who has performed a predetermined act during a predetermined time, using the log that is received from the client terminal. In this case, the predetermined time may be 24 hours. Also, the predetermined act may designate an act of trying to access a server but failing, an act of playing a game in a particular mode, and the like.

Generally, since a huge amount of log data exists, it takes considerably long time to process the log data. Accordingly, the pre-processing is performed with respect to a simple calculation which can be widely utilized and is associated with a large number of data, such as a number of simultaneous connectors, a total amount of game money, a number of users who performed a particular act, and the like. In other cases, a corresponding process is performed when a user's request is received. Accordingly, the collected log may be effectively managed.

Since the log management system collects a log in the client terminal, the log management system updates the client application to collect additional log data when the additional log data is required. In this case, when the client application accesses the online service server via the network, the log management system may update the client application or the log collecting module which is installed in the client application, to collect the additional log data. Generally, updating of the client application may be frequently executed for updating an online service version, installing an additional patch, and the like.

As described above, a program of the online service server is not updated, and a client application program is updated to collect the additional log data. Accordingly, the online service server is not required to be blocked. Also, the log management system shown in FIG. 2 may effectively collect a log without a need to dump a huge amount of data at once. Also, the log management system may immediately analyze the collected log. Accordingly, logs with respect to different online services may be automatically managed.

Also, a log is collected via a client application which is frequently restarted and accessed to a server. Accordingly, when a user's inappropriate access to an online service, such as a hacking attempt, occurs, the inappropriate access may be handled by quickly analyzing the collected log. Also, stability of the online service may be improved.

In this case, although not shown in FIG. 2, the log management system may further include a log management terminal which accesses the log management server 230 via the network, and receives a log that is stored in the log management server 230. The log management terminal may be a computer, a pocket PC, a notebook computer, a PDA, a mobile terminal, a game device, and the like.

In the case of an online service provider which provides a different online service, when the online service provider collects a log in the client application and transmits the collected log to the log management server 230 in a predetermined format, the online service provider may effectively analyze its online service log by using the log management terminal.

Accordingly, an operator may effectively collect/manage all types of logs with respect to various types of online services in the log management server 230, and also easily access the collected logs via the Internet.

Also, since the log management terminal accesses not the online service server but the log management server 230 to receive the stored log, the log management system according to the present disclosure may secure data in the online service server.

The log management server 230 shown in FIG. 2 may provide a template where an item of a collected log is set. Accordingly, an operator of various applications may create a subject including desired log items by using the template. Also, the operator may update the client application so that the client terminal may transmit a log corresponding to each of the log items included in the created subject. Through this, the log may be effectively collected and managed. In this case, the subject may correspond to a table which is utilized for storing the collected log in the log management server 230.

Also, the template, which is provided from the log management server 230, may be divided into a pre-processing template and into a post-processing template. In the pre-processing template, an item may not be arbitrarily deleted or changed and a received log is pre-processed to be stored. Also, in the post-processing template, an item may be arbitrarily deleted or changed and a received log may be processed using various types of structured query language (SQL) queries. When log items corresponding to the subject that is created using the pre-processing template is received in the log management server 230, the log items are stored via the preprocessing such as counting.

Operators of various online services may share the template. Specifically, since operators of similar online services may share a preset template, an online service log may be effectively managed.

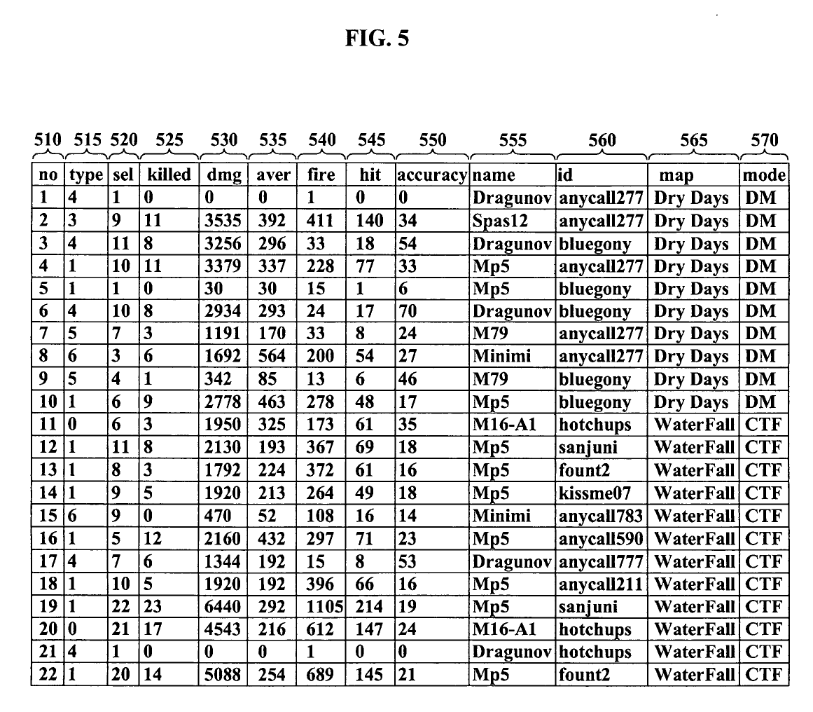

FIG. 5 is a diagram illustrating an example of a log stored in a log management server according to an exemplary embodiment of the present disclosure.

Referring to FIG. 5, it can be seen that a ‘Gunster’ game log, which is provided in a ‘hangame’ site (http://www.hangame.com), is stored in a log management server. In this case, the ‘Gunster’ game log shown in FIG. 5 is collected in a client application of a client terminal, and transmitted from the client terminal to the log management server via a network.

Each column of the log shown in FIG. 5 shows a game record for each game player, and includes a serial number 510, a weapon type 515, a number of selections 520, a number of killings 525, a total damage 530, an average damage 535, a number of fires 540, a number of hits 545, an accuracy 550, a gun name 555, a user identifier 560, a map 565, and a game mode 570.

The serial number 510 designates a line number in a log table. Accordingly, each number in the serial number 510 corresponds to an individual record of a single game player.

The weapon type 515 designates a gun which a user used in a game, and is also an identifier ne-to-one corresponding to the gun name 555.

The number of selections 520 designates a number of selections that the user selected a weapon corresponding to the weapon type 515 while playing a game for a single stage.

The number of killings 525 designates a number of killings that the user killed component characters using the weapon corresponding to the weapon type 515.

The total damage 530 designates a total damage that the user caused to the component characters in the game.

The average damage 535 designates an average damage of a single fire of the gun.

The number of fires 540 designates a number of fires that the user shot the gun in the game.

The number of hits 545 designates a number of hits that the user hit the component characters.

The accuracy 550 designates how accurately the user shot the gun. As an example, the accuracy 550 may be acquired by dividing the number of hits 545 by the number of fires 540 and multiplying the result of the division and 100.

The gun name 555 designates a name of a gun one-to-one corresponding to the weapon type 515.

The user identifier 560 designates an identifier of a user, i.e. a game user.

The map 565 is utilized for the game. In FIG. 5, it can be seen that two types of maps, ‘dray days’ and ‘waterfall’ are utilized for the map 565.

The game mode 570 designates a mode of a game. In FIG. 5, it can be seen that two modes ‘DM’ and ‘CTF’ are utilized for the game mode 570. In this case, the ‘DM’ designates a death match mode, and the ‘CTF’ designates a capture the flag mode. In the death match mode, an individual user or a team kills component characters and a side which has a greater number of killings wins the game. In the capture the flag mode, a team captures a component character team's flag which is located in the component character team's base, to the team's own base.

As described above, when an online service such as an online game is performed by an interoperation between the client application and the server application, the log management system according to the present exemplary embodiment collects the log of the online service in the client application, and transmits the log which is collected in the log transmission module of the client terminal, and thereby, enables the collected log to be stored in the log collecting server in a format as shown in FIG. 5.

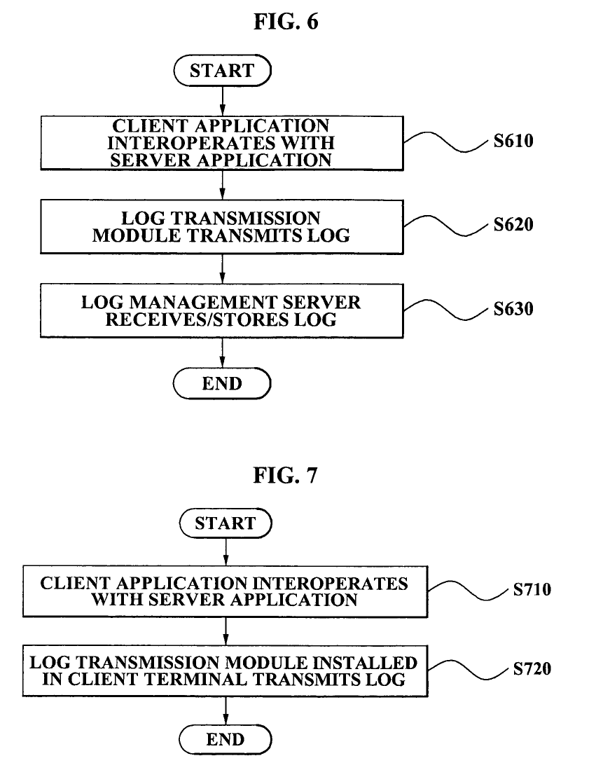

FIG. 6 is a flowchart illustrating a log management method according to an exemplary embodiment of the present disclosure.

Referring to FIG. 6, in the log management method according to the present exemplary embodiment, in operation S610, a client application interoperates with a server application via a network. The client application is executed in a client terminal, and the server application is executed in an online service server.

In this case, the client application collects the log of the online service in interoperation with the server application.

In this case, at least two client terminals may be installed in the client application. Also, at least two online service servers may provide a different server application. Also, at least two client applications may be installed in a single client terminal. Also, at least two online service servers may be provided for a single online service. As an example, 8 online service servers may be provided for the ‘You're the king of golf’ game service.

In operation S620, a log transmission module which is installed in the client terminal, transmits the collected log in a predetermined format at a predetermined point in time via the network.

In this case, the log transmission module may be provided to correspond to each client application. Also, at least two client applications may share a single log transmission module.

Also, the log transmission module may transmit the collected log at certain time intervals. As an example, the log transmission module may transmit the log every one minute while the client application is being executed.

Also, the log transmission module may transmit the collected log when the client application is terminated.

Also, a log may be transmitted at 80 ports using an HTTP via the network. Accordingly, the collected log may be easily transmitted in any type of client model. Also, it is possible to prevent blocking of a transmission which is caused by a router or a firewall.

In operation S630, when the log is transmitted, a log management server receives and stores the log which is transmitted via the network.

In this case, when additional log data is required, the log management method updates the client application to collect the additional log data. Also, when the client application accesses the online service server via the network, the log management method may update the client application.

Accordingly, additional log data may be collected without blocking the online service by updating only the client application program, while not updating the online service server program. Generally, the client application is frequently updated due to upgrading of an online service version. Accordingly, the client application may be easily updated in comparison with updating of the server application.

Each operation shown in FIG. 6 may be performed in an order shown in FIG. 6 or in an inversed order to the order shown in FIG. 6.

FIG. 7 is a flowchart illustrating a log transmission method according to an exemplary embodiment of the present disclosure.

Referring to FIG. 7, in the log transmission method according to the present exemplary embodiment, in operation S710, a client application interoperates with a server application via a network. The client application is executed in a client terminal, and the server application is executed in an online service server.

In this case, the client application collects the log of the online service in interoperation with the server application.

In this case, at least two client terminals may be installed in the client application. Also, at least two online service servers may provide a different server application. Also, at least two client applications may be installed in a single client terminal. Also, at least two online service servers may e provided for a single online service.

In operation S720, a log transmission module which is installed in the client terminal, transmits the collected log in a predetermined format at a predetermined point in time via the network.

Description related to operation S620 shown in FIG. 6 may be applied to operation S720 of FIG. 7. Accordingly, further detailed description related to operation S720 will be omitted.

Each operation shown in FIG. 7 may be performed in an order shown in FIG. 7 or in an inversed order to the order shown in FIG. 7.

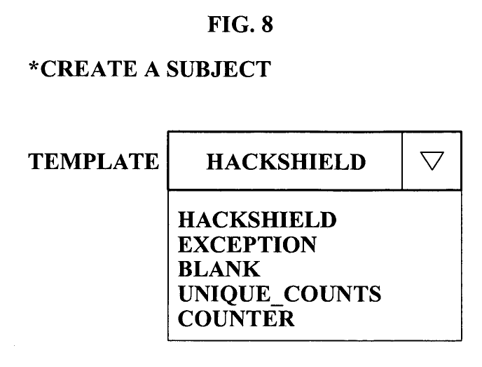

FIG. 8 is a diagram illustrating an example of a template which is provided in a log management server shown in FIG. 2, according to an exemplary embodiment of the present disclosure.

Referring to FIG. 8, the log management server shown in FIG. 2 provides the template. In FIG. 8, each of templates is embodied in a pull-down menu, to make a user to easily select a desired template.

In this case, “unique_counts” and “couter” templates may be pre-processing templates. Also, “hackshield”, “exception”, and “blank” templates may be post-processing templates.

The “blank” template is an empty template. Accordingly, the user may create a subject by setting desired log items.

When corresponding log items are set in the “hackshield” template and the “exception” template, the user may change a preset log item or add an additional log item.

Also, when corresponding log items are set in the “unique_counts” template and the “counter” template, the user may not change the preset log item or may not add the additional log item. In the case of the pre-processing template, the pre-processing is set to execute a predetermined calculation using log items. Accordingly, when the user arbitrarily changes the preset log item or adds the additional log item, a problem may occur.

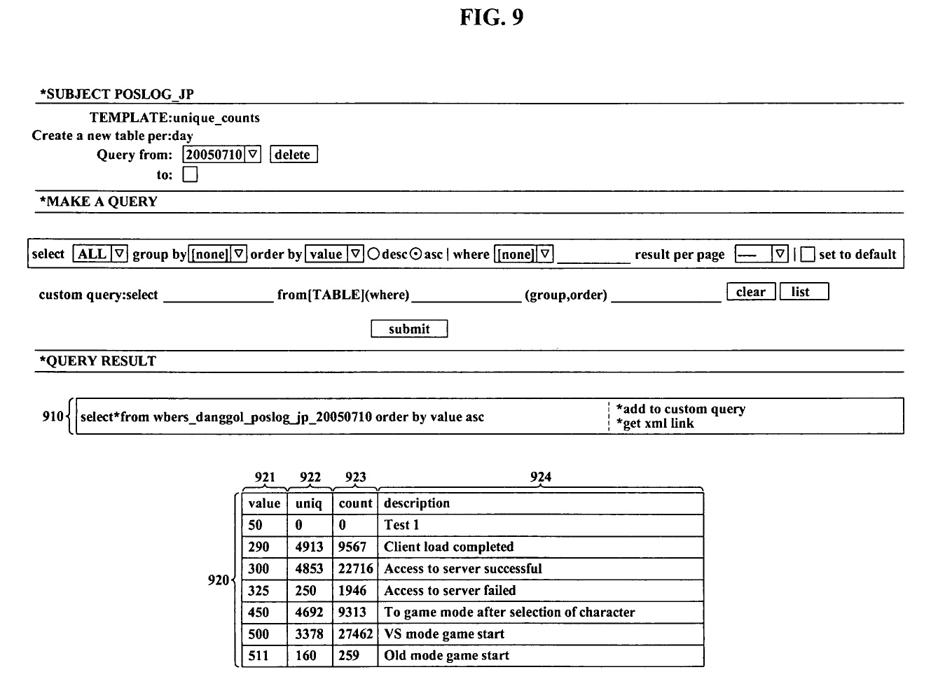

FIG. 9 is a diagram illustrating an example of a log providing screen of a subject which is created using a pre-processing template, according to an exemplary embodiment of the present disclosure.

Referring to FIG. 9, it can be seen that a log after Jul. 10, 2005, of a “POSLOG_JP” subject which is created using the “unique_counts” template shown in FIG. 8, is displayed in a result display unit 920.

In this case, a query display unit 910 may display an SQL query corresponding to the “POSLOG_JP” subject.

In this case, a portion of or all of items 921, 922, 923, and 924 may be created by processing the log which is collected in the client terminal and transmitted from the client terminal.

As shown in FIG. 9, when the subject is created by using the pre-processing template, the log management server pre-processes the received log, and stores the pre-processed log, not storing the received log as it is. When performing a simple calculation with respect to a huge amount of data, the log may be effectively managed by pre-processing the received log.

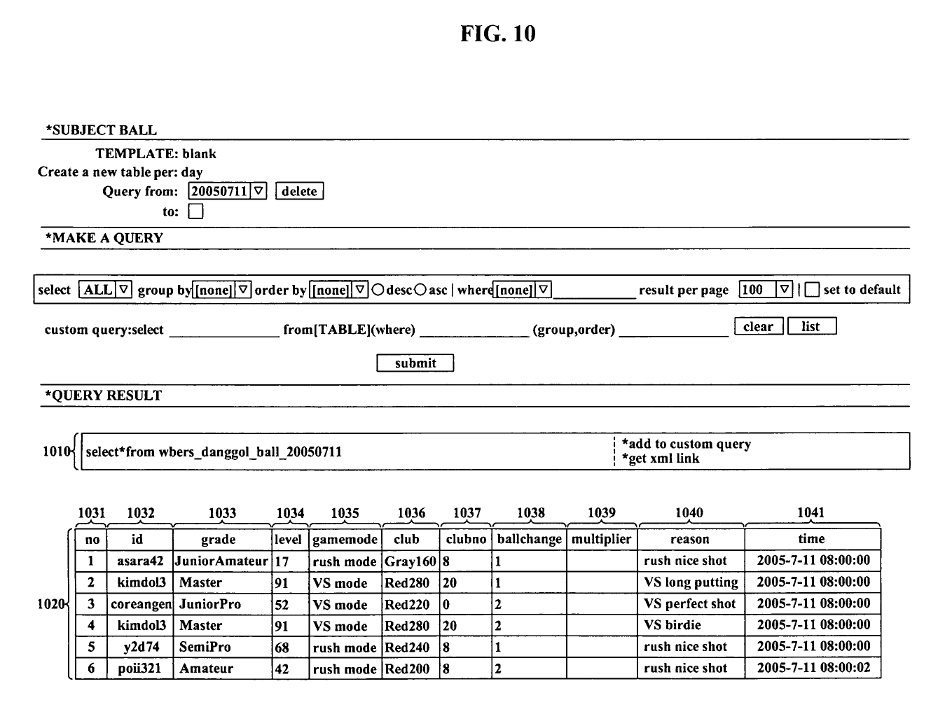

FIG. 10 is a diagram illustrating an example of a log providing screen of a subject which is created using a post-processing template, according to an exemplary embodiment of the present disclosure.

Referring to FIG. 10, it can be seen that a log after Jul. 11, 2005, of a “BALL” subject which is created by using the “blank” template is displayed in a result display unit 1020.

In this case, a log corresponding to a portion of or all of items 1031, 1032, 1033, 1034, 1035, 1036, 1037, 1038, 1039, 1040, and 1041 is collected in the client terminal and transmitted from the client terminal. The log management server initially stores the transmitted log, processes the log according to an SQL query which is displayed in the query display unit 1010, and provides the processed log in the result display unit 1020.

Also, since the “blank” template does not include a log item, each of the items1031, 1032, 1033, 1034, 1035, 1036, 1037, 1038, 1039, 1040, and 1041, which are displayed in the result display unit 1020, are log items which the user added when creating the subject.

As shown in FIG. 10, when the subject is created by using the post-processing template, the log management server stores the received log as it is, post-processing the received log according to an SQL query, and provides the post-processed log. Accordingly, an unnecessary processing time and load may be reduced. Also, the log may be effectively managed.

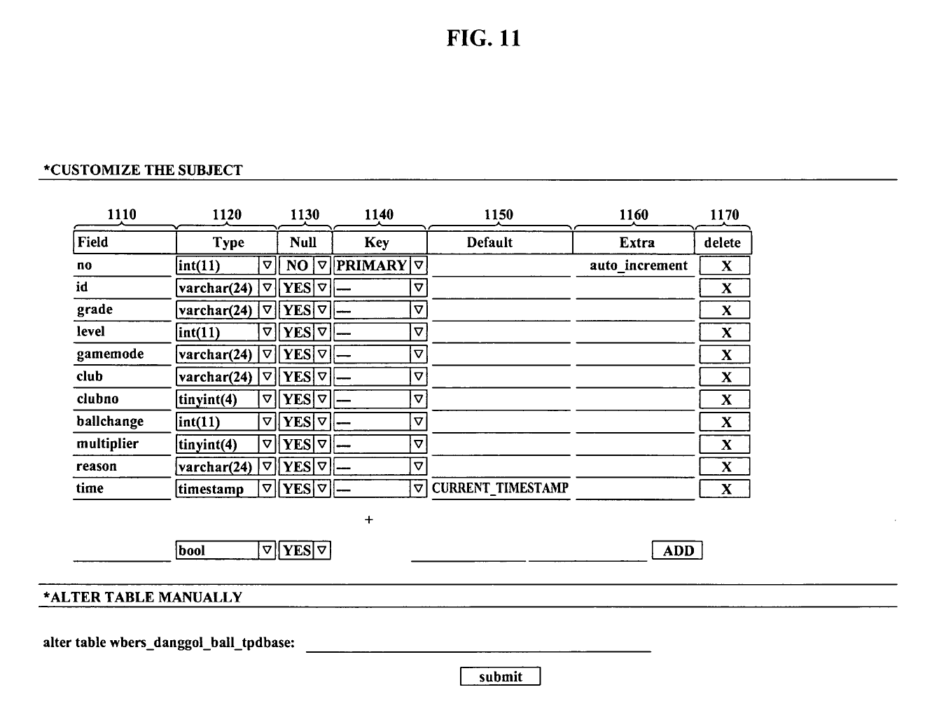

FIG. 11 is a diagram illustrating an example of a screen for setting a subject shown in FIG. 10, according to an exemplary embodiment of the present disclosure.

Referring to FIG. 11, it can be seen that a field name 1110, a field type 1120, a null unit 1130, a key 1140, a default 1150, extra information 1160, and a delete button 1170 are available for each item, so as to collect information about a portion of or all of the items 1031, 1032, 1032, 1033, 1034, 1035, 1036, 1037, 1038, 1039, 1040, and 1041, which are shown in FIG. 10.

The field name 1110 corresponds to a name of each column of the result display unit 1020 shown in FIG. 10, and includes “no”,“id”, “grade”, and the like.

The field type 1120 designates a data type of each item corresponding to each column of the result display unit 1020.

The null unit 1130 designates whether a corresponding item can be deleted. As an example, when the null unit 1130 is set as “YES”, the corresponding item may be deleted when transmitting/receiving the log. Also, when the null unit 1130 is set as “NO”, the corresponding item must be included when transmitting/receiving the log.

The key 1140 designates a key value setting in a database.

The default 1150 designates a default value to be applied when a corresponding item is not transmitted from a client side, since the corresponding item can be deleted when the null unit 1130 is set as “YES”.

The extra information 1160 is for setting extra information which is necessary for each item. As an example, the extra information 1160 may be set as “auto_increment” for a “no” item, so that the “no” item may be automatically incremented by one.

The delete button 1170 is for deleting the corresponding item.

A client terminal may collect the log as displayed in the result display unit 1020 of FIG. 10 by setting up necessary items as shown in FIG. 11, creating a subject, and setting a client program so that a client side transmits log information corresponding to each item of the created subject. When an additional item is required, the additional item is additionally registered in the subject shown in FIG. 11. Also, the field name 1110, the field type 1120, the null unit 1130, the key 1140, the default 1150 and the extra information 1160 may be set. When any of the set items is determined to be unnecessary, a corresponding item may be deleted by using the delete button 1170.

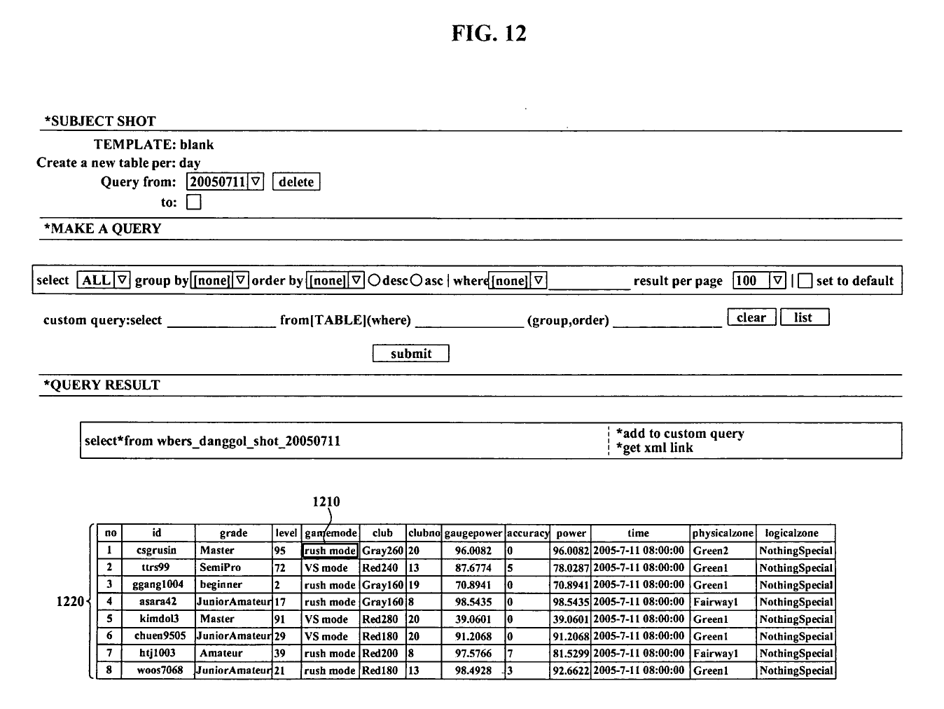

FIG. 12 is a diagram illustrating an example of a screen which is provided via a log management server according to an exemplary embodiment of the present disclosure.

Referring to FIG. 12, it can be seen that a log with respect to a “SHOT” subject which is created using the “blank” template is displayed in a result display unit 1220.

In this case, when a predetermined field of the result display unit 1220 is clicked, the log management server may provide detailed information of the clicked field or provide a result which is arranged based on the clicked field. The detailed information may be results which are acquired by selecting logs having an equal value to the clicked field.

When a “rushmode” field 1210 is clicked in the result display unit 1220 shown in FIG. 12, the log management server may select only logs having a “gamemode” item as “rushmode”, and provide the selected logs.

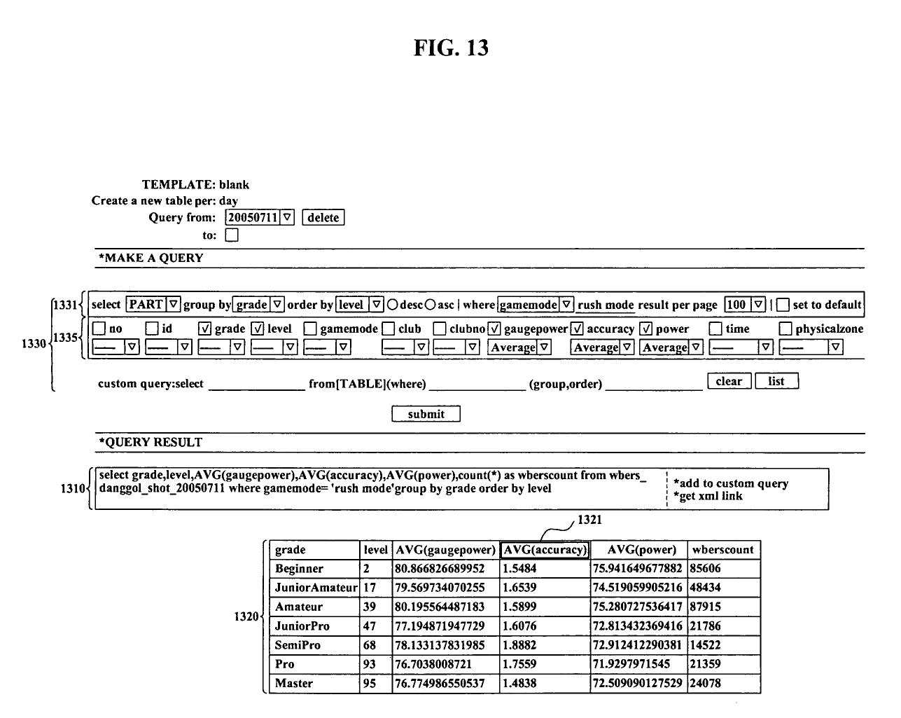

FIG. 13 is a diagram illustrating another example of a screen which is provided via a log management server according to an exemplary embodiment of the present disclosure.

Referring to FIG. 13, the log management server provides a query display unit 1310, a result display unit 1320, and a query generation unit 1330.

The query generation unit 1330 enables a user to generate an SQL query via a pointing device, such as a mouse, using a pull-down menu and a check box.

The query generation unit 1330 includes a first generation unit 1331 and a second generation unit 1335. The first generation 1331 is activated at all times, and may include the pull-down menu and the check box.

The second generation unit 1335 may be activated only when a particular item is selected in the first generation unit 1331, and may also include the pull-down menu and the check box.

In FIG. 13, the second generation unit 1335 is inactivated when a “select” item of the first generation unit 1331 is set as “ALL”, and activated only when the “select” item is selected as “PART”.

The query display unit 1310 displays an SQL query which is generated in the query generation unit 1330.

In FIG. 13, since the “select” item of the first generation unit 1331 is set as “PART”, the second generation unit 1335 is activated. Also, a “grade” item, a “level” item, a “gaugepower” item, an “accuracy” item, and a “power” item are checked in the second generation unit 1335. In this case, “average” is set for each of the “gaugepower” item, the “accuracy” item, and the “power” item. Also, in the first generation unit 1331, a “group by” item is selected as “grade”, an “order by” item is selected as “level”, a “where” item is selected as “gamemode”, and “rushmode” is inputted.

Accordingly, the query display unit 1310 displays an SQL query, “select grade, level, AVG(gaugepower), AVG(accuracy), AVG(power), count(*) as wberscount from wbers_danggol_shot_{—}20050711 where gamemode=‘rushmode’ group by grade order by level”. In this case, “count(*) as wberscount” may be automatically inserted when the group by” item of the first generation unit 1331 is set.

Accordingly, as described above, even a user who does not know a complicated SQL grammar may easily generate a desired SQL query by manipulating a mouse.

The result display unit 1320 displays a log which is processed according to the SQL query which is displayed in the query display unit 1310.

When an “AVG(accuracy)” field 1321 is clicked in the result display unit 1320, the log management server may arrange the logs displayed in the result display unit 1320 according to an ascending series or a descending series, based on an “AVG(accuracy)” value.

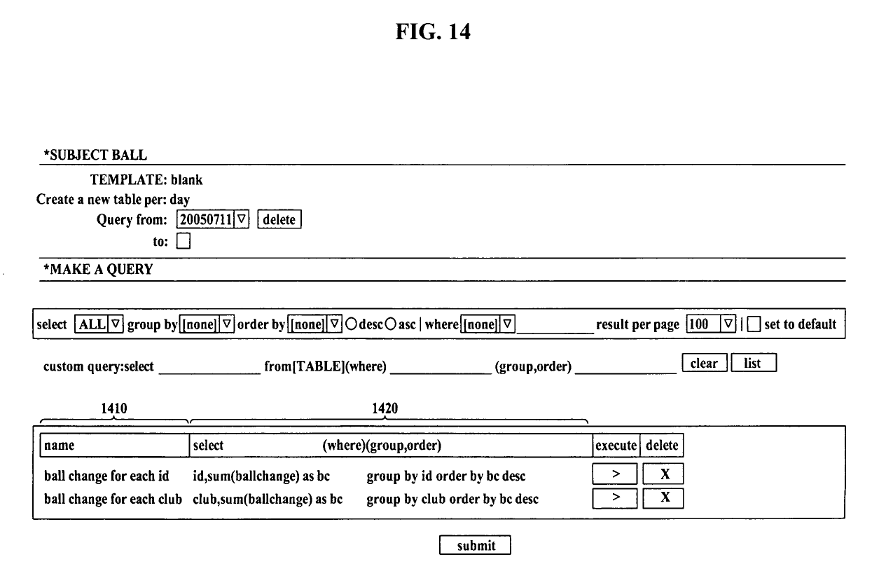

FIG. 14 is a diagram illustrating still another example of a screen which is provided via a log management server according to an exemplary embodiment of the present disclosure.

FIG. 14 may be a screen which is displayed when a particular list of the query generation unit 1330 shown in FIG. 13 is clicked.

Referring to FIG. 14, it can be seen that the log management server stores an SQL query 1420 corresponding to a natural language 1410, such as Hangul. Accordingly, when a user's desired natural language is selected, the log management server processes the stored log using the SQL query corresponding to the selected natural language, and provides the user with the processed log.

According to embodiments, an SQL query which is frequently utilized in various types of applications is stored in a table, corresponding to a natural language, so that many users can share the table. Accordingly, as necessary, the users may easily generate and utilize a desired SQL query.

As described with FIGS. 12 through 14, the log management system according to the present exemplary embodiment may easily process the collected log using only a pointing device, such as, a mouse, while not using a complicated SQL query. In this case, the processing includes a simple calculation, such as a selection, grouping, arranging, and counting with respect to particular log data.

Also, FIGS. 8 through 14 may be screens which are displayed on the log management terminal that is connected to the log management server via the network.

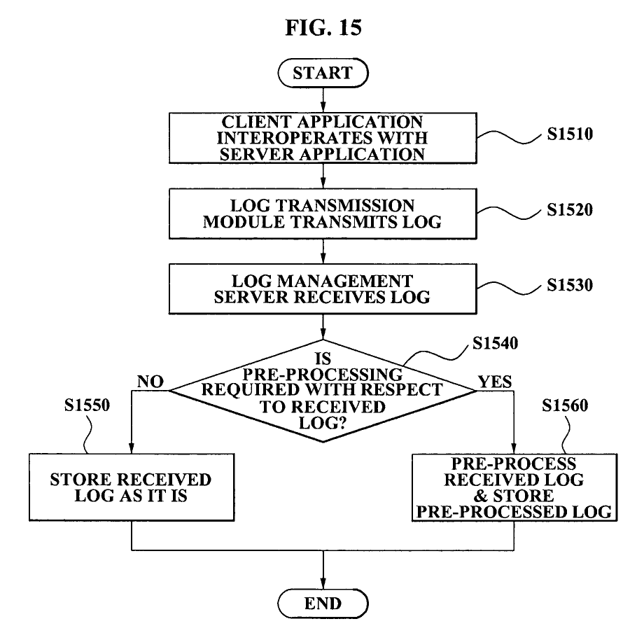

FIG. 15 is a flowchart illustrating a log management method according to another exemplary embodiment of the present disclosure.

Referring to FIG. 15, in the log management method according to the present embodiment, in operation S1510, a client application interoperates with a server application via a network. The client application is executed in a client terminal, and the server application is executed in an online service server.

In this case, the client application collects the log of the online service in interoperation with the server application.

In this case, at least two client terminals may be installed in the client application. Also, at least two online service servers may provide a different server application. Also, at least two client applications may be installed in a single client terminal. Also, at least two online service servers may be provided for a single online service. As an example, 8 online service servers may be provided for the ‘You're the king of golf’ game service.

In operation S1520, a log transmission module which is installed in the client terminal, transmits the collected log in a predetermined format at a predetermined point in time via the network.

In this case, the log transmission module may be provided to correspond to each client application. Also, at least two client applications may share a single log transmission module.

Also, the log transmission module may transmit the collected log at certain time intervals. As an example, the log transmission module may transmit the log every one minute while the client application is being executed.

Also, the log transmission module may transmit the collected log when the client application is terminated.

Also, a log may be transmitted at 80 ports using HTTP via the network. Accordingly, the collected log may be easily transmitted in any type of client model. Also, it is possible to prevent blocking of a transmission which is caused by a router or a firewall.

In operation S1530, when the log is transmitted, a log management server receives and stores the log which is transmitted from the client terminal via the network.

In operation S1540, the log management method determines whether a pre-processing is required for the received log.

In this case, the necessity of the pre-processing with respect to the received log may be determined, depending upon whether the received log corresponds to a subject that is created by using a pre-processing template or to a subject that is created by using a post-processing template.

In operation S1550, the log management method stores the received log as it is when the pre-processing is not required.

In operation S1560, the log management method pre-processes the received log and stores the pre-processed log, when the pre-processing is required.

In this case, the received log may be processed and stored for each subject.

According to embodiments, the log management method displays detailed information of a selected field or arranges log information, based on the selected field, when the field of a log information screen is selected, and generates an SQL query using a pull-down menu and a check box, and processes the stored log according to the SQL query, and when a natural language is selected, processes the stored log according to the selected natural language, using a table which stores the SQL query corresponding to the natural language, and provides the processed log.

Also, the log management method may update the client application to collect additional log data when the additional log data is required. Also, when the client application accesses the online service server via the network, the client application may be updated.

Accordingly, additional log data may be collected without blocking the online service by updating only the client application program, while not updating the online service server program. Generally, the client application is frequently updated due to upgrading of an online service version. Accordingly, the client application may be easily updated in comparison with updating of the server application.

Each operation shown in FIG. 15 may be performed in an order shown in FIG. 15 or in an inversed order to the order shown in FIG. 15.

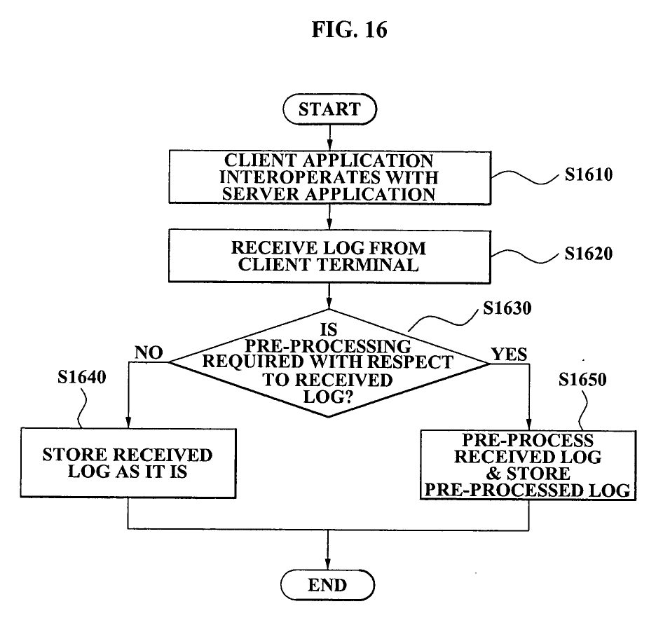

FIG. 16 is a flowchart illustrating a log management method according to still another exemplary embodiment of the present disclosure.

Referring to FIG. 16, in the log management method according to the present exemplary embodiment, in operation S1610, a client application interoperates with a server application via a network. The client application is executed in a client terminal, and the server application is executed in an online service server.

In this case, the client application collects the log of the online service in interoperation with the server application.

In this case, at least two client terminals may be installed in the client application. Also, at least two online service servers may provide a different server application. Also, at least two client applications may be installed in a single client terminal. Also, at least two online service servers may be provided for a single online service.

In operation S1620, the log transmission method receives the log from the client terminal.

In operation S1630, the log management method determines whether a pre-processing is required for the received log.

In operation S1640, the log management method stores the received log as it is when the pre-processing is not required.

In operation S1650, the log management method pre-processes the received log and stores the pre-processed log, when the pre-processing is required.

Description related to operations shown in FIG. 15 may be applied to operations of FIG. 16. Accordingly, further detailed description related to operations of FIG. 16 will be omitted.

Each operation shown in FIG. 16 may be performed in an order shown in FIG. 16 or in an inversed order to the order shown in FIG. 16.

The log management method according to the above-described exemplary embodiment of the present disclosure may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present disclosure.

According to the present disclosure, there is provided a log management system and method which can easily manage a log of an online service at any desired time without blocking an online service.

Also, according to the present disclosure, there is provided a log management system and method which enables a distributed client side, not a server side, to collect log data and transmit the collected log data every time the log data is collected, and thereby can quickly analyze the collected log data without a need to dump a huge amount of data at once.

Also, according to the present disclosure, there is provided a log management system and method which can quickly collect an additional log while not blocking online service, even when a client side collects log data and also is required to collect an additional log.

Also, according to the present disclosure, there is provided a log management system and method which can automatically collect and manage logs corresponding to online service servers that provide different online services.

Also, according to the present disclosure, there is provided a log management system and method which enables any user to easily apply a log in various types of environments by transmitting the log using an HTTP, and also can prevent blocking of a transmission which is caused by a router or a firewall.

Also, according to the present disclosure, there is provided a log management system and method which can immediately analyze a collected log and instantaneously handle a hacking attempt.

Also, according to the present disclosure, there is provided a log management system and method which can pre-process and store a portion of collected logs immediately when the portion of logs is collected, and post-process remaining logs while storing the remaining logs, and thereby can effectively manage a huge amount of log data.

Also, according to the present disclosure, there is provided a log management system and method which can effectively collect and manage log data with respect to various types of applications by providing a template where an item of a collected log is set.

Also, according to the present disclosure, there is provided a log management system and method which can change a selection, grouping, and an arrangement method with respect to collected logs by simply manipulating a pointing device such as a mouse.

Also, according to the present disclosure, there is provided a log management system and method which enables various types of online service operators to share a frequently utilized template, an SQL query, and the like, and thereby can effectively manage a log.

Although a few exemplary embodiments of the present disclosure have been shown and described, the present disclosure is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An event management system comprising:
a retrieval module configured to retrieve event information about an online service from an online service server via a network link, the online service being configured to operate in the online service server; and
a transmission module configured to communicate the retrieved event information to an event management server at a predetermined interval.

2. The system of claim 1, wherein the retrieval module is configured to retrieve additional event information when the additional event information is required.

3. The system of claim 1, wherein the transmission module is configured to communicate with the online service when additional event information is required.

4. The system of claim 1, wherein the transmission module is configured to communicate the retrieved event information at a predetermined time interval while the retrieval module is retrieving event information.

5. The system of claim 1, wherein the transmission module is configured to communicate the retrieved event information when the retrieval module finishes retrieving event information.

6. The system of claim 1, wherein the transmission module is configured to communicate the retrieved event information in the form of a file identifiable by a Uniform Resource Locator using the HyperText Transfer Protocol.

7. The system of claim 1, wherein the transmission module is configured to communicate the retrieved event information using the Simple Object Access Protocol.

8. An event management server system comprising:
a receiving module configured to receive retrieved event information about an online service; and
a storage module configured to store the retrieved event information in association with the online service with which the event information is associated.

9. The system of claim 8, further comprising:
a processing module configured to determine whether a pre-processing is required when storing the retrieved event information, and configured to pre-process the retrieved event information using the determination.

10. The system of claim 9, wherein the processing module is further configured to pre-process or post-process the retrieved event information according to a template, and wherein the storage module is configured to store the processed retrieved event information.

11. The system of claim 10, wherein the processing module is further configured to provide a subject for the retrieved event information using the template, and wherein the storage module is configured to store the processed retrieved event information in association with the subject.

12. The system of claim 10, wherein the post-processing includes changing preset information on a retrieved event or adding additional information on a retrieved event.

13. The system of claim 8, further comprising:
a processing module configured to generate an SQL query using a pull-down menu and a check box, and configured to process the retrieved event information using the SQL query.

14. The system of claim 8, further comprising:
a storage module configured to store a table including an SQL query corresponding to a natural language; and
a processing module configured to process the retrieved event information using the SQL query when the natural language is selected.

15. The system of claim 8, further comprising an event management terminal.

16. The system of claim 8, further comprising:
a communication module configured to communicate with the storage module to receive the retrieved event information.

17. The system of claim 16, further comprising:
a display module configured to display an event information screen including at least one selectable field, and further configured to display information of the at least one selectable field or arrange retrieved event information in response to selecting the at least one selectable field.

18. A method of managing a log comprising:
retrieving event information about an online service from an online service server via a network link, the online service being configured to operate in the online service server; and
communicating the retrieved event information to an event management server at a predetermined interval.

19. The method of claim 18, further comprising retrieving additional event information by communicating with the online service when additional event information is required.

20. The method of claim 17, further comprising communicating the retrieved event information in the form of a file identifiable by a Uniform Resource Locator using the HyperText Transfer Protocol.

21. The method of claim 17, further comprising communicating the retrieved event information using the Simple Object Access Protocol.

22. A method of managing a log comprising:
receiving retrieved event information about an online service; and
storing the retrieved event information in association with the online service with which the information is associated.

23. The method of claim 21, further comprising:
determining whether a pre-processing is required when storing the retrieved event information;
pre-processing or post-processing the retrieved event information according to a template and the determination; and
storing the processed retrieved event information.

24. The method of claim 22, further comprising:
providing a subject for the retrieved event information using the template;
storing the processed retrieved event information in association with the subject.

25. The method of claim 21, further comprising:
displaying an event information screen including at least one selectable field;
displaying information of the at least one selectable field or arranging retrieved event information in response to selecting the at least one selectable field;
generating an SQL query using a pull-down menu and a check box;
processing the retrieved event information using the SQL query;
storing a table including an SQL query corresponding to a natural language; and
processing the retrieved event information using the SQL query when the natural language is selected

26. The method of claim 22, wherein the retrieved event information is received in the form of a file identifiable by a Uniform Resource Locator using the HyperText Transfer Protocol, and wherein the pre-processing determination is made using a file identifiable by a Uniform Resource Locator using the HyperText Transfer Protocol.

27. The method of claim 22, wherein the retrieved event information is received in the form of a file using the Simple Object Access Protocol, and wherein the pre-processing determination is made using a file using the Simple Object Access Protocol.

28. A computer-readable medium storing instructions when executed perform a method comprising:
retrieving event information about an online service from an online service server via a network link, the online service being configured to operate in the online service server; and
communicating the retrieved event information to an event management server at a predetermined interval.
